(19) United States
(12) Patent Application Publication
(10) Pub. No.: US 2004/0051033 A1
(43) Pub. Date: Mar. 18, 2004

(54) Method of controlling deflection amplitude and offset of a resonant scanning mirror using photo detector timing

(76) Inventors: Mark D. Hagen, Rochester, MN (US); James E. Noxon, Rochester, MN (US); Arthur M. Turner, Allen, TX (US)

Correspondence Address: TEXAS INSTRUMENTS INCORPORATED, P O BOX 655474, M/S 3999, DALLAS, TX, 75265

(21) Appl. No.: 10/243,410

(22) Filed: Sep. 13, 2002

(51) Int. Cl. H01J 3/14; H01J 5/16

(52) U.S. Cl. 250/234

(57) ABSTRACT

A system and method are provided for controlling the deflection amplitude and offset of a laser beam that is deflected off of a vibrating mirror galvanometer, given only beam deflection timing information.

### BACKGROUND OF THE INVENTION

1. Field of the Invention

This invention relates generally to micro-electro-mechanical system (MEMS) mirrors, and more particularly, to a method of controlling a resonant scanning mirror using only laser beam deflection timing.

2. Description of the Prior Art

It would be desirable and advantageous in the MEMS mirror art to provide a technique for controlling the deflection amplitude and offset of a laser beam that is deflected off of a vibrating mirror galvanometer, given only beam deflection timing information.

### SUMMARY OF THE INVENTION

The present invention is directed to a system and method for controlling the deflection amplitude and offset of a laser beam that is deflected off of a vibrating mirror galvanometer, given only beam deflection timing information.

According to one embodiment, a method of controlling a resonant scanning mirror comprises the steps of: measuring deflection timing associated with a laser beam deflected off the resonant scanning mirror in response to movement of the resonant scanning mirror; and controlling the deflection amplitude and offset of the laser beam in response to deflection timing measurements.

According to another embodiment, a method of controlling a resonant scanning mirror comprises the steps of: providing two photo detectors equally spaced apart from the center of the deflection range associated with the resonant scanning mirror; measuring a delta time associated with a deflected laser beam moving between the two photo detectors in response to movement of the resonant scanning mirror; and controlling the deflection amplitude and offset of the laser beam in response to the delta time measurements.

According to yet another embodiment, a system for controlling the deflection amplitude and offset of a laser beam that is deflected off of a vibrating mirror galvanometer comprises: a resonant scanning mirror; a pair of photo detectors spaced equally apart from the center of the deflection range associated with the resonant scanning mirror; timing detection logic configured to calculate a time sum and a time difference associated with a deflected laser beam moving between the pair of photo detectors; a digital processor configured to calculate a control effort in response to the time sum and time difference; a pair of digital to analog converters (DACs) configured to convert the control effort to a voltage; a sinewave generator configured to generate a sinewave in response to the control effort; and a voltage amplifier configured to generate a resonant scanning mirror motor coil voltage in response to the sinewave.

### BRIEF DESCRIPTION OF THE DRAWINGS

Other aspects, features and advantages of the present invention will be readily appreciated, as the invention becomes better understood by reference to the following detailed description when considered in connection with the accompanying drawing figures wherein:

FIG. 1 is a pictorial diagram illustrating two photo detectors near both ends of the deflection range associated with a resonant scanning mirror that is deflecting a laser beam;

FIG. 2 is a waveform diagram illustrating digital pulses generated by the two photo detectors depicted in FIG. 1 as the deflected laser beam sweeps from side to side;

FIG. 3 is a diagram illustrating the relationship between deflected laser beam amplitude and waveform timing for the digital pulses shown in FIG. 2;

FIG. 4 is a three-dimensional graph illustrating the functional relationship between a defined time tₛᵤₘ and the laser beam deflection amplitude and offset for the system shown in FIG. 1;

FIG. 5 is a three-dimensional graph illustrating the functional relationship between a defined time t_{diff} and the laser beam deflection amplitude and offset for the system shown in FIG. 1;

FIG. 6 is a simplified schematic diagram illustrating a complete system for controlling the amplitude and offset of a deflected laser beam and that is suitable for use in association with the system shown in FIG. 1, to control the amplitude and offset of the deflected laser beam by measuring the time from the initial detection of the laser beam at the left sensor to the detection of the laser beam at the right sensor;

FIG. 7 shows a more detailed schematic of the timing detection logic circuit that is depicted in FIG. 6;

FIG. 8 shows a more detailed schematic of the state machine signal conditioner that is depicted in FIG. 7;

FIG. 9 is a system diagram illustrating the topology of a digital control loop for maintaining deflection amplitude and offset associated with the system depicted in FIGS. 6-8;

FIG. 10 is a pictorial diagram illustrating two mirrors and a single laser detector, each mirror located near one end of the deflection range associated with a resonant scanning mirror that is deflecting a laser beam;

FIG. 11 is a waveform diagram depicting a sinusoidal displacement of the laser beam deflected off the resonant scanning mirror that is seen by the laser detector as well a window function generated by the forcing function of the resonant scanning mirror shown in FIG. 10;

FIG. 12 depicts two output signals generated using the window function and detector output signal shown in FIG. 12;

FIG. 13 is similar to FIG. 3, and shows the relationship between deflected laser beam amplitude and the length of the positive-going pulses shown in FIG. 12;

FIG. 14 shows another more detailed schematic of the timing detection logic circuit that is depicted in FIG. 6 and that is suitable for use by the system shown in FIG. 10; and

FIG. 15 shows a more detailed schematic of the state machine signal conditioner that is depicted in FIG. 14.

While the above-identified drawing figures set forth particular embodiments, other embodiments of the present invention are also contemplated, as noted in the discussion. In all cases, this disclosure presents illustrated embodiments of the present invention by way of representation and not limitation. Numerous other modifications and embodiments can be devised by those skilled in the art which fall within the scope and spirit of the principles of this invention.

### DETAILED DESCRIPTION OF THE PREFERRED EMBODIMENTS

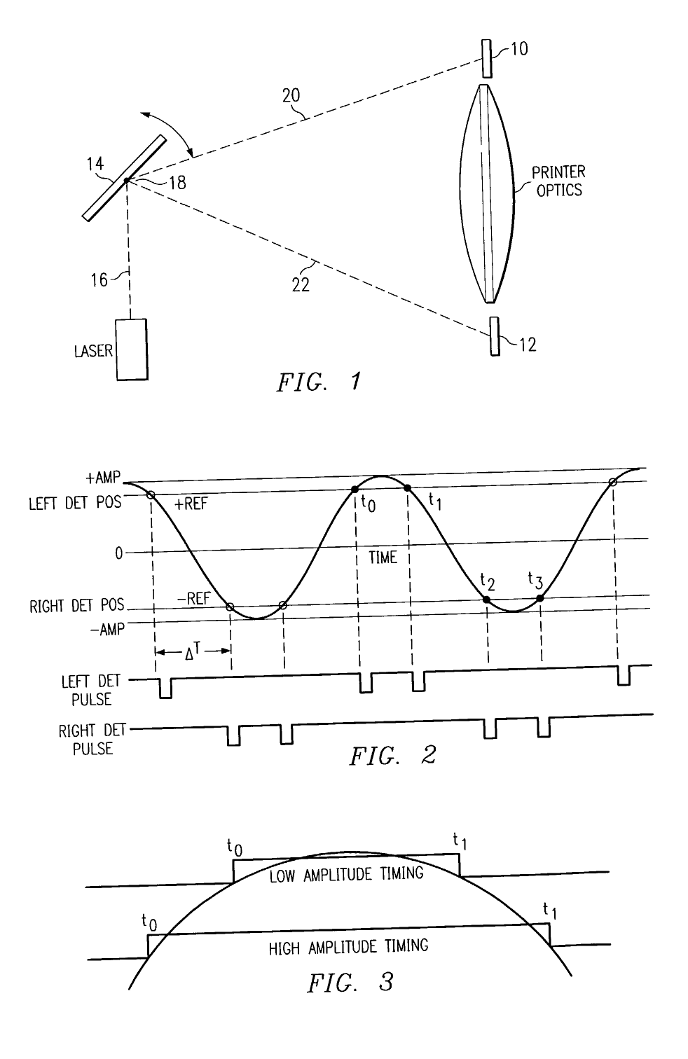

The particular embodiments of the invention discussed herein below with reference to FIGS. 1-9 are directed to a system and method for controlling the deflection amplitude and offset of a laser beam that is deflected off of a vibrating mirror galvanometer, given only beam deflection timing information.

Looking first at FIG. 1, a pictorial diagram illustrates two photo detectors 10, 12 near both ends of the deflection range associated with a resonant scanning mirror 14 that is deflecting a laser beam 16. Each photo detector 10, 12 is a known, but equal distance from the center 18 of the deflection. As the beam sweeps from side 20 to side 22, the photo detectors 10, 12 will generate pulses as shown in FIG. 2.

FIG. 2 is a waveform diagram illustrating digital pulses generated by the two photo detectors 10, 12 depicted in FIG. 1 as the deflected laser beam 16 sweeps from side 20 to side 22. The deflection amplitude and offset are related to the sensor 10, 12 times by a relationship written as

det pos=ref=A cos(ωtₙ)+b. (1)

If the detectors 10, 12 are positioned near 70% of the desired full deflection amplitude, then each detector 10, 12 pulse appears in a different quadrant of the unit circle. For each respective quadrant, equation (1) becomes

$$\frac{( ref - b )}{A} = cos ( - ω {t}_{0} ) , \\ \frac{( ref - b )}{A} = cos ( - ω {t}_{1} ) , \\ \frac{( ref + b )}{A} = cos ( π - ω {t}_{2} ) , and$$

$$\frac{( ref + b )}{A} = cos ( ω {t}_{3} - π ) .$$

When the amplitude of the deflection is low, the time from t₀ to t₁ and the time from t₂ to t₃ will become short. Likewise, when the deflection amplitude is large, these time deltas will increase; so measuring these times will generate a value that is a function of amplitude. FIG. 3 is a diagram illustrating the relationship between deflected laser beam amplitude and waveform timing for the digital pulses shown in FIG. 2. This function can be concisely written as

$${t}_{left} = {t}_{1} - {t}_{0} = \frac{1}{w} ( {cos}^{- 1} ( \frac{ref - b}{A} ) + {cos}^{- 1} ( \frac{ref - b}{A} ) ) = \frac{2}{w} {cos}^{- 1} ( \frac{ref - b}{A} )$$

$${t}_{right} = \frac{2}{w} {cos}^{- 1} ( \frac{ref + b}{A} )$$

A value defined as tₛᵤₘ can then be written as

$${t}_{sum} = {t}_{left} + {t}_{right} = \frac{2}{w} ( {cos}^{- 1} ( \frac{ref - b}{A} ) + {cos}^{- 1} ( \frac{ref + b}{A} ) ) \qquad ( 2 )$$

It can be seen that when there is a positive offset to the beam 16 deflection, the timing t_{left} will increase and the timing t_{right} will decrease. In view of the foregoing, a value that tracks deflection offset t_{diff} can then be defined as

t_{diff}=t_{left}−t_{right} (3)

Solving equation (2) for amplitude A, and solving equation (3) for offset b then shows the relationship between the timing measurements and amplitude and offset as

$$\begin{matrix}A = \frac{ref}{cos ( \frac{ω}{4} {t}_{sum} ) cos ( \frac{ω}{4} {t}_{diff} )} , and & ( 4 ) \\ b = ref tan ( \frac{ω}{4} {t}_{sum} ) tan ( \frac{ω}{4} {t}_{diff} ) . & ( 5 )\end{matrix}$$

It can then be shown that around the desired operating point (when the offset b is zero and the reference value is 70.7% of the deflection amplitude A), equations (4) and (5) can be respectively approximated as

$$A \approx \frac{ref}{cos ( \frac{ω}{4} {t}_{sum} )} , and$$

$$b \approx ref tan ( \frac{ω}{4} {t}_{diff} ) .$$

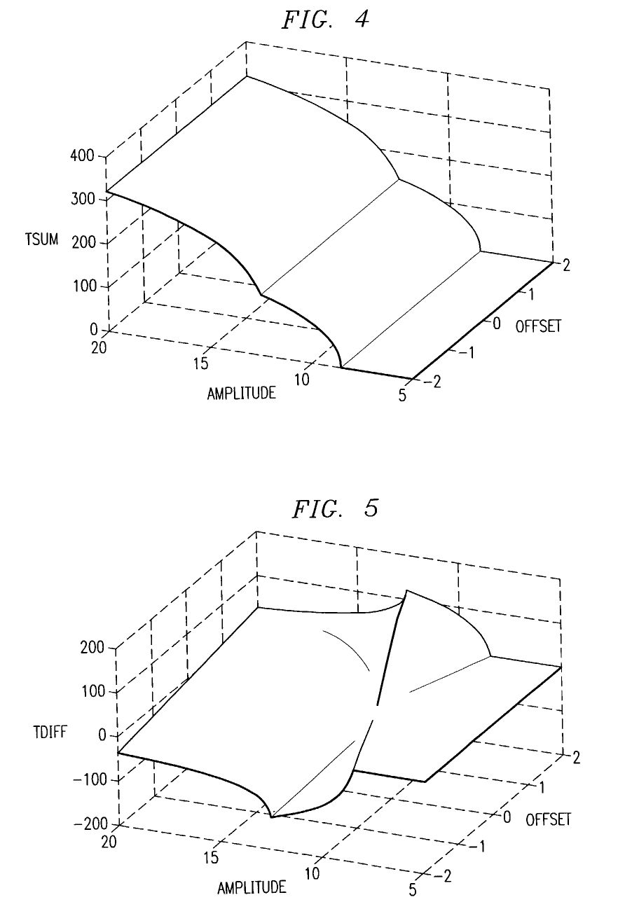

FIG. 4 is a three-dimensional graph illustrating the functional relationship between the defined time tₛᵤₘ and the laser beam deflection amplitude A and offset b for the system topology shown in FIG. 1. FIG. 5 is a three-dimensional graph illustrating the functional relationship between the defined time t_{diff} and the laser beam deflection amplitude A and offset b for the system shown in FIG. 1. In this case, deflection is measured in degrees of mirror 14 rotation; and time is in 1 MHz clock periods. The present inventors have found that in practice, a higher frequency clock can be used to increase resolution. Looking at FIGS. 4 and 5, it can be seen that at some amplitudes A or offsets b, the deflected laser beam 16 will not cross both detectors 10, 12; and so only two of the four detector pulses will be generated. In this case, the missing t_{left} or t_{right} values are defined as zero. The result then is that there are three regimes that a controller must consider. These can be described as 1) No detection: Operate open loop and step increase the amplitude control; 2) Left or Right detection only: Amplitude and offset gain is ˜half, so double controller gain; and 3) both detector times available: Use gain as described herein above.

With continued reference to FIGS. 4 and 5, it can be seen that the slope of the tₛᵤₘ surface with respect to amplitude is around 40 clocks/degree; and the slope of the t_{diff} surface with respect to offset is around 60 clocks/degree (near the desired operating point). It can therefore be seen that a sufficient measure is available to use to control the deflection amplitude and offset of the laser beam.

In view of the above, a discussion regarding the MEMS mirror 14 coil driver is now set forth below. If the beam deflection equations are re-arranged to be in terms of the time the beam takes to cross the working area, that is from t₁ to t₂, then amplitude can be expressed as

$$A = \frac{ref}{sin ( ω \frac{{t}_{2} - {t}_{1}}{2} )} . \qquad ( 6 )$$

Therefore, if the deflection angle of the detectors 10, 12 and the sweep frequency of the mirror 14 are known, the amplitude from the time it takes the beam to swing from the left side detector 10 to the right side detector 12 can be calculated.

Since the sensitivity of the system to changing amplitude can be determined from equation (6), the change in amplitude that must be maintained can be determined as shown below if the change in period that can be tolerated is known and if the period is roughly ΔT.

$$T = \frac{2}{ω} {sin}^{- 1} ( \frac{y}{A} ) = \frac{2}{ω} {sin}^{- 1} ( a ) for y = aA$$

$$\frac{ⅆ T}{ⅆ A} = \frac{- 2 y}{{ω}^{2} {{A}^{2} ( 1 - \frac{{y}^{2}}{{A}^{2}} )}^{\frac{1}{2}}}$$

$$ⅆ T = \frac{- 2}{ω} \frac{a}{{( 1 - {a}^{2} )}^{\frac{1}{2}}} \frac{ⅆ A}{A}$$

If the detectors 10, 12 are positioned such that they are at 70.7% of the full deflection, then the percent change in amplitude can be expressed as a function of an incremental change in timing as follows.

$$\frac{ⅆ A}{A} = π f ⅆ T = 6283 ⅆ T , \qquad ( 7 )$$

and for a 10 nsec change in timing, dT, equation (7) becomes

$$\frac{ⅆ A}{A} \approx {2}^{- 14} .$$

At least 14 bits of resolution on the amplifier will therefore be necessary to control the mirror 14 deflection.

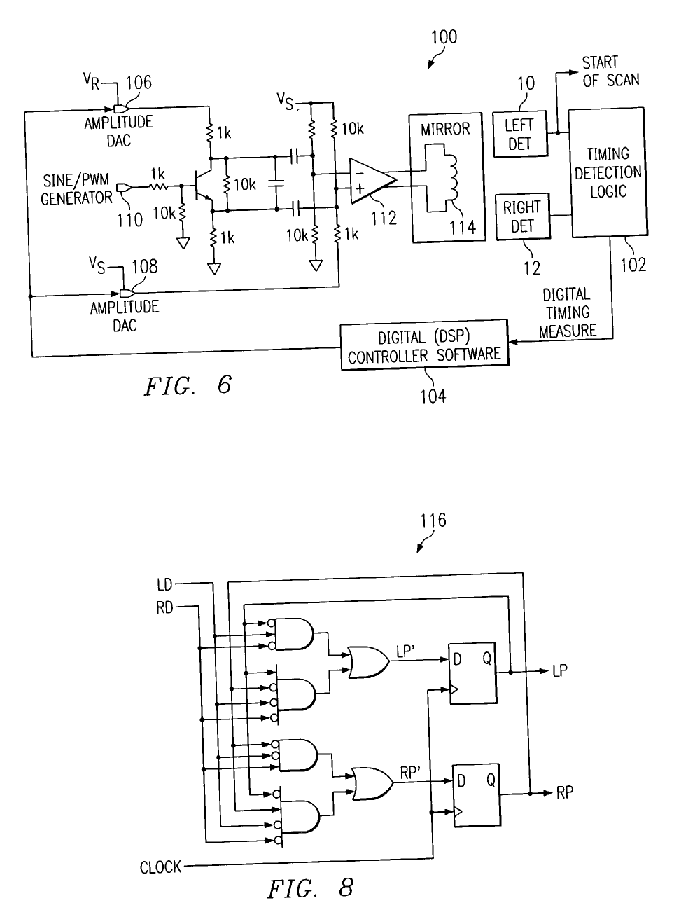

FIG. 6 is a simplified schematic diagram illustrating a complete system 100 for controlling the amplitude of a deflected laser beam 16 and that is suitable for use in association with the system shown in FIG. 1, to control the amplitude of the deflected laser beam 16 by measuring the time from the initial detection of the laser beam 20 at the left sensor 10 to the detection of the laser beam 22 at the right sensor 12. System 100 comprises a left photo detector 10; a right photo detector 12; timing detection logic 102 that calculates the time sum and difference from the left and right detectors 10, 12; a digital processor 104 to calculate a control effort; an amplitude DAC 106 and an offset DAC 108 to convert the control effort values to voltages; a sinewave generator 110 having its amplitude modulated by the control effort; and a voltage amplifier 112 to drive the mirror motor coil 114. According to one embodiment, the coil 114 is driven by an H-bridge voltage amplifier that employs a crystal controlled PWM signal to generate a sinusoidal drive waveform, wherein the amplitude of the drive signal is controlled via a 16-bit DAC, for example.

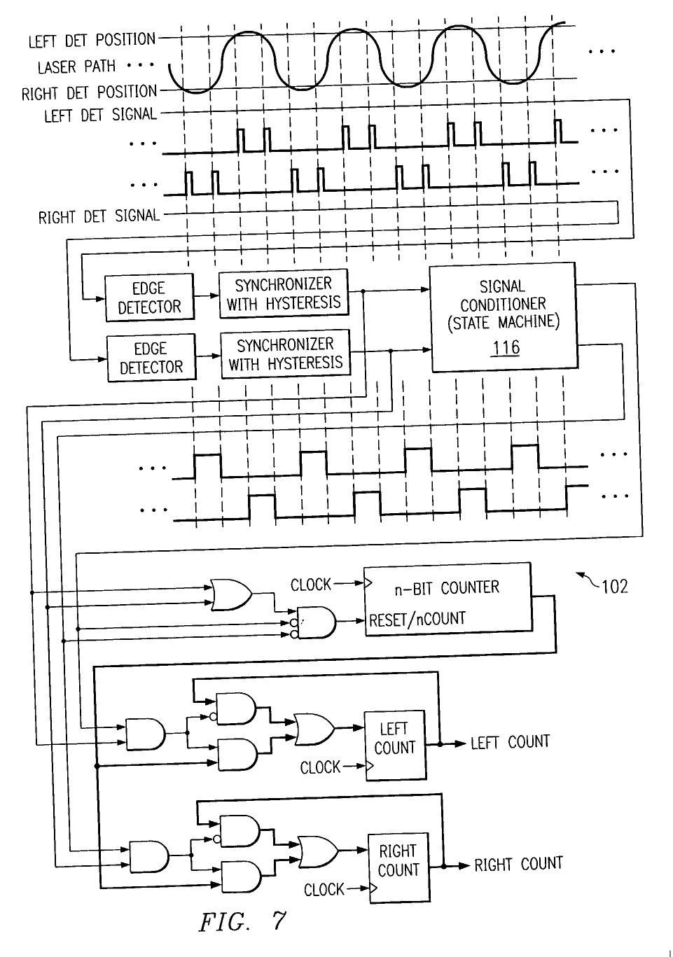

FIG. 7 shows a more detailed schematic of the timing detection logic circuit 102 that is depicted in FIG. 6. The timing detection logic circuit 102 is operational to measure the above described t_{left} and t_{right} time intervals (the time from left detector 10 to left detector 10 and from right detector 12 to right detector 12).

FIG. 8 shows a more detailed schematic of the state machine signal conditioner 116 that is depicted in FIG. 7. The state machine signal conditioner 116 design is based on Truth Table 1 shown below.

Truth Table 1

| | | Current | Current | Next | Next | |
|---|---|---|---|---|---|---|
| | | Left | Right | Left | Right | |
| Left | Detector | Pulse | Pulse | Pulse | Pulse | |
| Detector | Detector | State | State | State | State | |
| (LD) | (RD) | (LP) | (RP) | (LP) | (RP) | Comments |
| 0 | 0 | 0 | 0 | 0 | 0 | If signaling no pulses and none detected, continue signaling no pulses |
| 0 | 0 | 0 | 1 | 0 | 1 | If signaling right pulse and none detected, continue signaling right pulse |
| 0 | 0 | 1 | 0 | 1 | 0 | If signaling left pulse and none detected, continue signaling left pulse |
| 0 | 0 | 1 | 1 | 0 | 0 | If signaling both pulses, error, signal no pulse |
| 0 | 1 | 0 | 0 | 0 | 1 | If signaling no pulses and right detected, begin signaling right pulse |
| 0 | 1 | 0 | 1 | 0 | 0 | If signaling right pulse and right detected, stop signaling right pulse |
| 0 | 1 | 1 | 0 | 0 | 1 | If signaling left pulse and right detected, begin signaling right pulse |
| 0 | 1 | 1 | 1 | 0 | 0 | If signaling both pulses, error, signal no pulse |
| 1 | 0 | 0 | 0 | 1 | 0 | If signaling no pulses and left detected, begin signaling left pulse |
| 1 | 0 | 0 | 1 | 1 | 0 | If signaling right pulse and left detected, begin signaling left pulse |
| 1 | 0 | 1 | 0 | 0 | 0 | If signaling left pulse and left detected, stop signaling left pulse |
| 1 | 0 | 1 | 1 | 0 | 0 | If signaling both pulses, error, signal no pulse |
| 1 | 1 | 0 | 0 | 0 | 0 | If left and right detected simultaneously, error, signal no pulse |
| 1 | 1 | 0 | 1 | 0 | 0 | If left and right detected simultaneously, error, signal no pulse |
| 1 | 1 | 1 | 0 | 0 | 0 | If left and right detected simultaneously, error, signal no pulse |
| 1 | 1 | 1 | 1 | 0 | 0 | Of left and right detected simultaneously, error, signal no pulse |

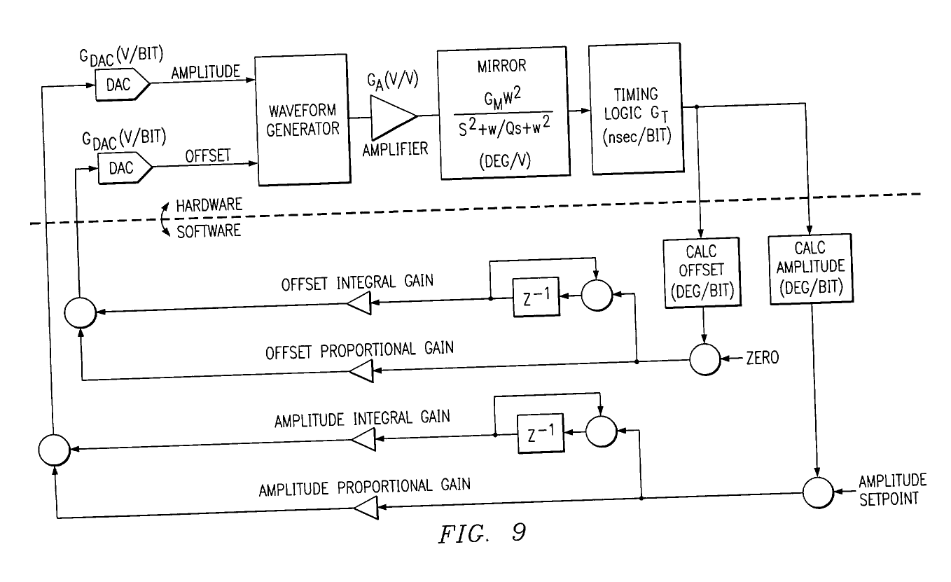

FIG. 9 is a system diagram illustrating the topology of a 5^{th} order digital control loop for maintaining deflection amplitude associated with the system depicted in FIGS. 6-8. The blocks below the dashed line represent functions implemented in code.

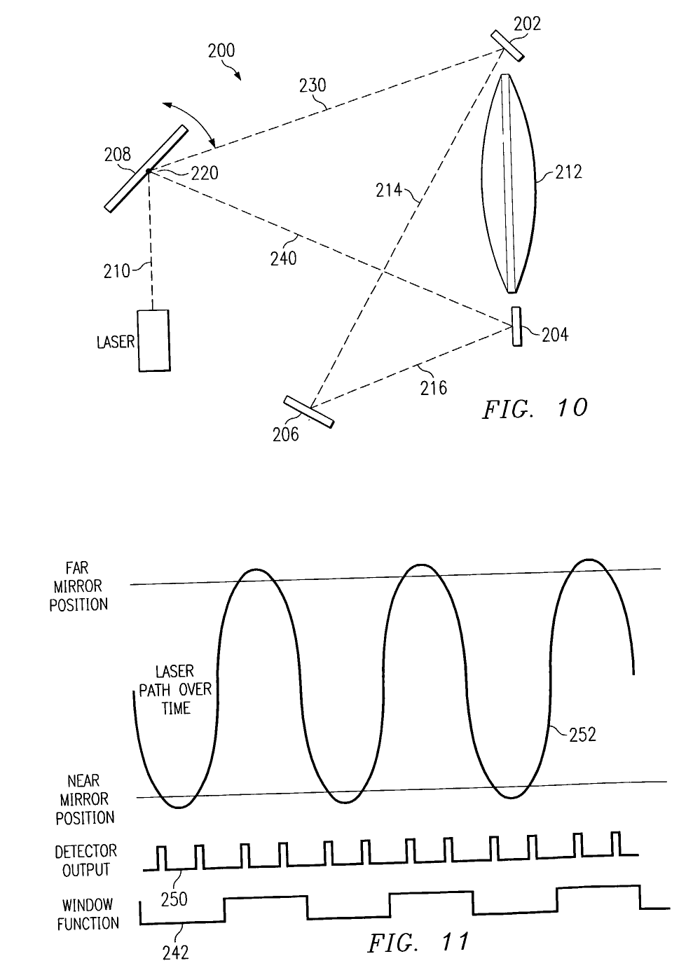

FIG. 10 is a pictorial diagram illustrating a system 200 that comprises a far mirror 202, a near mirror 204, and a single laser detector 206, wherein each mirror is located near one end of the deflection range associated with a resonant scanning mirror 208 that is deflecting a laser beam 210 generated by a laser generator. The resonant scanning mirror 208 generates a sinusoidal displacement of the laser beam 210 that is greater than the printer optics 212 range. When the deflected laser beam (enumerated as 230 and 240 in FIG. 10) crosses the far or near mirrors 202, 204 (which are fixed position mirrors), a beam 214, 216 is reflected to the single laser detector 206.

FIG. 11 is a waveform diagram depicting a sinusoidal displacement of the laser beam deflected off the resonant scanning mirror 208 that is seen by the laser detector 206 as well a window function 242 generated by the forcing function of the resonant scanning mirror 208 shown in FIG. 10.

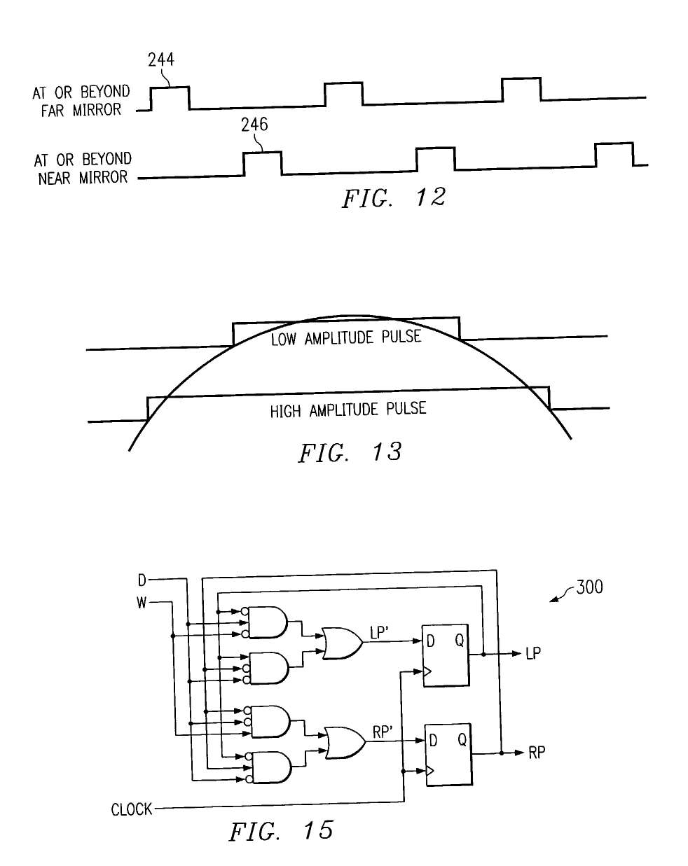

FIG. 12 depicts two output signals 244, 246 generated using the window function 242 and detector 206 output signal 250 shown in FIG. 12. If the amplitude of the sinusoid 252 shown in FIG. 11 is represented by the length of the positive-going pulses 244, 246 from the “At or Beyond” signals, then a longer pulse signifies a larger amplitude.

FIG. 13 depicts a diagram that is similar to the diagram shown in FIG. 3, and shows the relationship between deflected laser beam amplitude and the length of the positive-going pulses 244, 246 shown in FIG. 12. The total amplitude of the sinusoid 252 is then represented as the length of the pulse from the far mirror 202 added to the length of the pulse of the near mirror 204. The result is subtracted from some expected total length to generate an amplitude error that can then be fed back to a controller in order to manage the amplitude of the sinusoid 252 by modifying the amplitude of the forcing function on the resonant scanning mirror 208.

If the sinusoid 252 is not centered between the far and near mirrors 202, 204, the pulse 244, 246 widths from the far and near mirrors 202, 204, will be dissimilar in length. Subtracting one pulse length from another yields an effective offset of the sinusoid from the center 220 shown in FIG. 10. This offset can similarly be fed back to a controller to manage the offset of the sinusoid 252 by modifying the offset of the forcing function on the resonant scanning mirror 208.

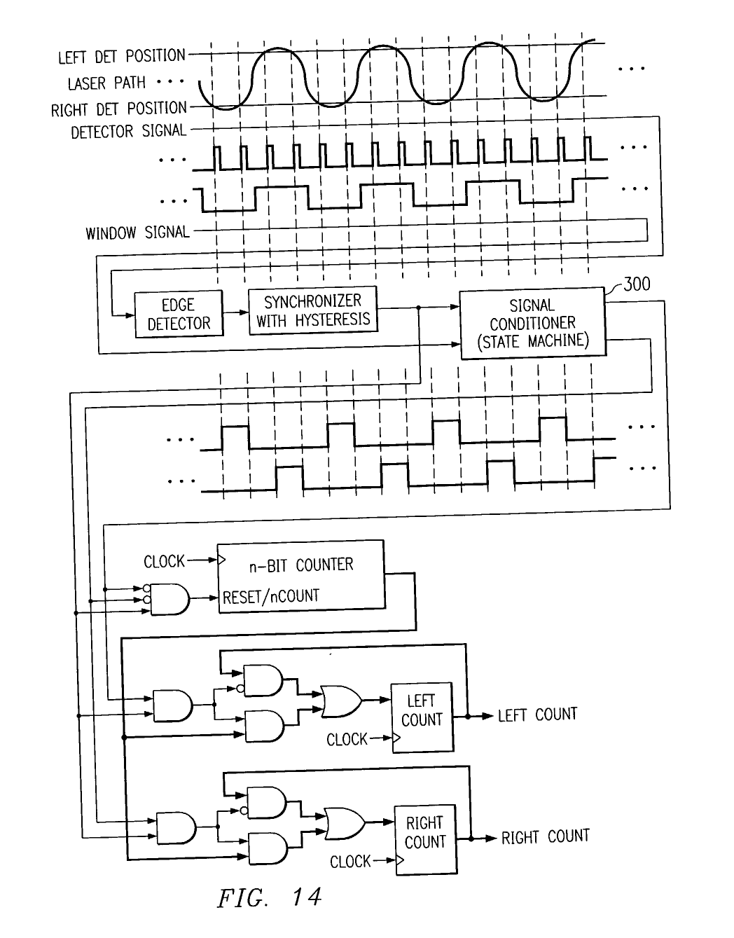

FIG. 14 shows a detailed schematic for another embodiment of the timing detection logic circuit 102 that is depicted in FIG. 6. The control system 100 is also suitable for use by the detector system 200 shown in FIG. 10 when the timing detection logic circuit 102 employs the structure shown in FIG. 14. Detector system 200 can be seen to be responsive to a single detector signal 250 as well as the window signal 242.

FIG. 15 shows a more detailed schematic of the state machine signal conditioner 300 that is depicted in FIG. 14. The state machine signal conditioner 300 design is based on Truth Table 2 shown below.

Trith Table 2

| | | Current | Current | Next | Next | |
|---|---|---|---|---|---|---|
| | | Left | Right | Left | Right | |
| | | Pulse | Pulse | Pulse | Pulse | |
| Detector | Window | State | State | State | State | |
| (D) | (W) | (LP) | (RP) | (LP) | (RP) | Comments |
| 0 | 0 | 0 | 0 | 0 | 0 | If signaling no pulses and none detected, continue signaling no pulse |
| 0 | 0 | 0 | 1 | 0 | 1 | If signaling right pulse and none detected, continue signaling right pulse |
| 0 | 0 | 1 | 0 | 1 | 0 | If signaling left pulse and none detected, continue signaling left pulse |
| 0 | 0 | 1 | 1 | 0 | 0 | If signaling both pulses, error, signal no pulse |
| 0 | 1 | 0 | 0 | 0 | 0 | If signaling no pulses and none detected, continue signaling no pulses |
| 0 | 1 | 0 | 1 | 0 | 1 | If signaling right pulse and none detected, continue signaling right pulse |
| 0 | 1 | 1 | 0 | 1 | 0 | If signaling left pulse and none detected, continue signaling left pulse |
| 0 | 1 | 1 | 1 | 0 | 0 | If signaling both pulses, error, signal no pulse |
| | 0 | 0 | 0 | 1 | 0 | If signaling no pulses and left detected, begin signaling left pulse |
| | 0 | 0 | 1 | 1 | 0 | If signaling right pulse and left detected, begin signaling left pulse |
| | 0 | 1 | 0 | 0 | 0 | If signaling left pulse and left detected, stop signaling left pulse |
| | 0 | 1 | 1 | 0 | 0 | If signaling both pulses, error, signal no pulse |
| | 1 | 0 | 0 | 0 | 1 | If signaling no pulses and right detected, begin signaling right pulse |
| | 1 | 0 | 1 | 0 | 0 | If signaling right pulse and right detected, stop signaling right pulse |
| 1 | 1 | 1 | 0 | 0 | 1 | If signaling left pulse and right detected, begin signaling right pulse |
| 1 | 1 | 1 | 1 | 0 | 0 | If signaling both pulses, error, signal no pulse |

In view of the above, it can be seen the present invention presents a significant advancement in the art of MEMS mirror controllers. Further, this invention has been described in considerable detail in order to provide those skilled in the resonant scanning mirror controller art with the information needed to apply the novel principles and to construct and use such specialized components as are required. In view of the foregoing descriptions, it should be apparent that the present invention represents a significant departure from the prior art in construction and operation. However, while particular embodiments of the present invention have been described herein in detail, it is to be understood that various alterations, modifications and substitutions can be made therein without departing in any way from the spirit and scope of the present invention, as defined in the claims which follow.

What is claimed is:

1. A method of controlling a resonant scanning mirror, the method comprising the steps of:
measuring deflection timing associated with a laser beam deflected off the resonant scanning mirror in response to movement of the resonant scanning mirror; and
controlling the deflection amplitude and offset of the laser beam in response to deflection timing measurements.

2. The method according to claim 1, wherein the step of measuring deflection timing associated with a laser beam deflected off the resonant scanning mirror in response to movement of the resonant scanning mirror comprises measuring a delta time between two photo detectors equally spaced apart from the center of the deflection range associated with the resonant scanning mirror.

3. The method according to claim 1, wherein the step of controlling the deflection amplitude and offset of the laser beam in response to deflection timing measurements comprises calculating deflection amplitude via applying a gain to a sum of the time the laser beam traverses a predetermined field of view associated with a first photo detector and the time the laser beam traverses a predetermined field of view associated with a second photo detector, wherein the photo detectors are spaced substantially equally apart from the center of the deflection range associated with the resonant scanning mirror.

4. The method according to claim 1, wherein the step of controlling the deflection amplitude and offset of the laser beam in response to deflection timing measurements comprises calculating deflection offset via applying a gain to a difference of the time the laser beam traverses a predetermined field of view associated with a first photo detector and the time the laser beam traverses a predetermined field of view associated with a second photo detector, wherein the photo detectors are spaced substantially equally apart from the center of the deflection range associated with the resonant scanning mirror.

5. The method according to claim 1, wherein the step of controlling the deflection amplitude and offset of the laser beam in response to deflection timing measurements comprises the steps of:
calculating amplitude data in response to the deflection timing measurements;
converting the amplitude data to a control voltage; and
driving a motor coil associated with the resonant scanning mirror via the control voltage.

6. The method according to claim 5, wherein the step of calculating amplitude data in response to the deflection timing measurements comprises calculating amplitude data via a digital signal processor in response to the deflection timing measurements.

7. The method according to claim 5 wherein the step of converting the amplitude data to a control voltage comprises the steps of:
converting the amplitude data to a voltage via a digital to analog converter; and
processing the voltage via a voltage amplifier to generate a resonant scanning mirror motor coil control voltage.

8. The method according to claim 1, wherein the step of controlling the deflection amplitude and offset of the laser beam in response to deflection timing measurements comprises the steps of:
calculating pulse width data in response to the deflection timing measurements;
converting the pulse width data to a control voltage; and
driving a motor coil associated with the resonant scanning mirror via the control voltage.

9. The method according to claim 8, wherein the step of calculating pulse width data in response to the deflection timing measurements comprises calculating pulse width data via a digital signal processor in response to the deflection timing measurements.

10. The method according to claim 8 wherein the step of converting the pulse width data to a control voltage comprises the steps of:
converting the pulse width data to a voltage via a digital to analog converter; and
processing the voltage via a voltage amplifier to generate a resonant scanning mirror motor coil control voltage.

11. A method of controlling a resonant scanning mirror, the method comprising the steps of:
providing two photo detectors spaced substantially equally apart from the center of the deflection range associated with the resonant scanning mirror;
measuring a delta time associated with a deflected laser beam moving between the two photo detectors in response to movement of the resonant scanning mirror; and
controlling the deflection amplitude and offset of the laser beam in response to the delta time measurements.

12. The method according to claim 11 wherein the step of controlling the deflection amplitude and offset of the laser beam in response to the delta time measurements comprises calculating the deflection amplitude via applying a gain to the sum of time the laser beam traverses a predetermined field of view associated with a first photo detector selected from the two photo detectors and the time the laser beam traverses a predetermined field of view associated with a second photo detector selected from the two photo detectors.

13. The method according to claim 11 wherein the step of controlling the deflection amplitude and offset of the laser beam in response to the delta time measurements comprises calculating the deflection offset via applying a gain to the difference of time the laser beam traverses a predetermined field of view associated with a first photo detector selected from the two photo detectors and the time the laser beam traverses a predetermined field of view associated with a second photo detector selected from the two photo detectors.

14. The method according to claim 11, wherein the step of measuring a delta time associated with a deflected laser beam moving between the two photo detectors in response to movement of the resonant scanning mirror comprises measuring deflection timing associated with a laser beam deflected off the resonant scanning mirror in response to movement of the resonant scanning mirror.

15. The method according to claim 11, wherein the step of controlling the deflection amplitude and offset of the laser beam in response to the delta time comprises the steps of:
calculating amplitude data in response to the delta time measurements;
converting the amplitude data to a control voltage; and
driving a motor coil associated with the resonant scanning mirror via the control voltage.

16. The method according to claim 15, wherein the step of calculating amplitude data in response to the delta time measurements comprises calculating amplitude data via a digital signal processor in response to the delta time measurements.

17. The method according to claim 15 wherein the step of converting the amplitude data to a control voltage comprises the steps of:
converting the amplitude data to a voltage via a digital to analog converter; and
processing the voltage via a voltage amplifier to generate a resonant scanning mirror motor coil control voltage.

18. The method according to claim 11, wherein the step of controlling the deflection amplitude and offset of the laser beam in response to the delta time comprises the steps of:
calculating pulse width data in response to the delta time measurements;
converting the pulse width data to a control voltage; and
driving a motor coil associated with the resonant scanning mirror via the control voltage.

19. The method according to claim 18, wherein the step of calculating pulse width data in response to the delta time measurements comprises calculating pulse width data via a digital signal processor in response to the delta time measurements.

20. The method according to claim 18 wherein the step of converting the pulse width data to a control voltage comprises the steps of:
converting the pulse width data to a voltage via a digital to analog converter; and
processing the voltage via a voltage amplifier to generate a resonant scanning mirror motor coil control voltage.

21. A system for controlling the deflection amplitude and offset of a laser beam that is deflected off of a vibrating mirror galvanometer, the system comprising:
a resonant scanning mirror;
a photo detector system configured to generate an output signal in response to a laser beam deflected by the resonant scanning mirror;
timing detection logic configured to calculate a time sum and a time difference associated with the deflected laser beam, in response to the photo detector output signal;
a digital processor configured to calculate a control effort in response to the time sum and time difference;
a pair of digital to analog converters (DACs) configured to convert the control effort to a voltage;
a sinewave generator configured to generate a sinewave in response to the control effort; and
a voltage amplifier configured to generate a resonant scanning mirror motor coil voltage in response to the sinewave.

22. The system according to claim 21 wherein the pair of digital to analog converters comprises:
a first DAC configured to control the amplitude of the deflected laser beam; and
a second DAC configured to control the offset of the deflected laser beam.

23. The system according to claim 21 wherein the photo detector system comprises a pair of photo detectors spaced equally apart from the center of the deflection range associated with the resonant scanning mirror, and wherein the timing detection logic is configured to calculate the time sum and a time difference associated with a deflected laser beam moving between the pair of photo detectors

24. The system according to claim 21 wherein the photo detector system comprises:
a pair of mirrors spaced equally apart from the center of the deflection range associated with the resonant scanning mirror; and
a single photo detector configured to generate the output signal in response to the laser beam deflected by the resonant scanning mirror.
